(19) United States
(12) Patent Application Publication
(10) Pub. No.: US 2007/0002059 A1
(43) Pub. Date: Jan. 4, 2007

(54) Pixel data compression from controller to display

(75) Inventors: Lawrence A. Booth, Phoenix, AZ (US); Anitha Kona, Austin, TX (US)

Correspondence Address: LeMOINE PATENT SERVICES, PLLC, C/O INTELLEVATE, P. O. BOX 52050, MINNEAPOLIS, MN, 55402, US

(73) Assignee: Intel Corporation

(21) Appl. No.: 11/169,537

(22) Filed: Jun. 29, 2005

(51) Int. Cl. G06F 15/80

(52) U.S. Cl. 345/505

(57) ABSTRACT

A display system includes a controller capable of compressing pixel data, and a display module capable of decompressing pixel data.

### FIELD

The present invention relates generally to electronic systems with displays, and more specifically to systems with pixel data compression.

### BACKGROUND

Many electronic systems in use today include display devices such as liquid crystal displays (LCDs). These systems typically provide pixel data to the display devices, and the display devices display an image corresponding to the pixel data.

### BRIEF DESCRIPTION OF THE DRAWINGS

FIG. 1 shows an electronic system with pixel data compression;

FIGS. 2-5 show display systems with pixel data compression;

FIG. 6 shows a diagram of an electronic system in accordance with various embodiments of the present invention; and

FIG. 7 shows a flowchart in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

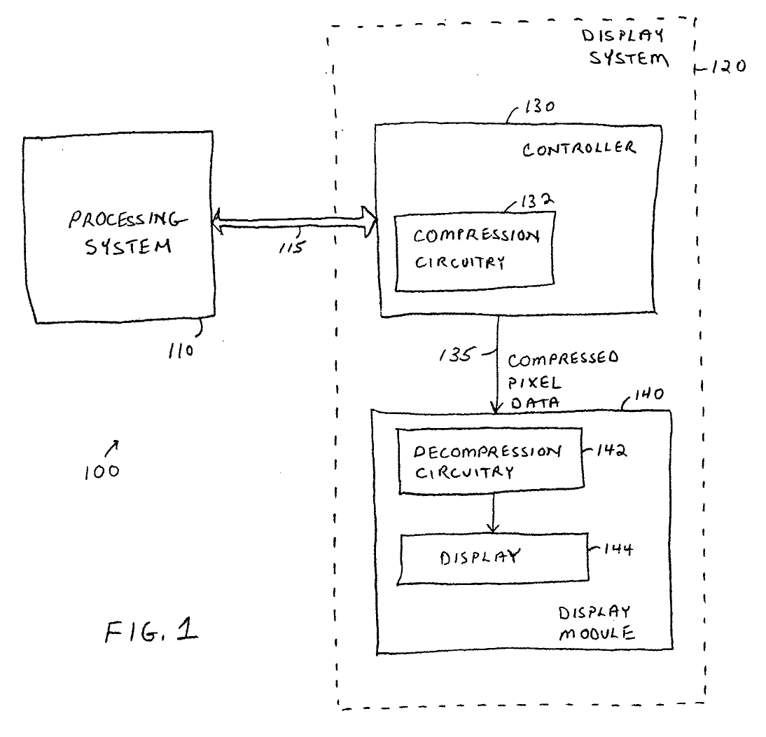

FIG. 1 shows an electronic system with pixel data compression. Electronic system 100 includes processing system 110 and display system 120. Processing system 110 may be any type of processing system, including for example, a processing system useful for cellular phones, personal digital assistants, handheld computers, desktop computers, and the like. Processing system 110 provides display data to display system 120 on bus 115. Display system 120 includes controller 130 and display module 140. In some embodiments, display 144 includes a liquid crystal display (LCD).

Controller 130 receives display data from processing system 110 and provides various functions. For example, controller 130 is capable of compressing pixel data using compression circuitry 132. Controller 130 provides compressed pixel data to display module 140 on node 135. Display module 140 decompresses the compressed pixel data using decompression circuitry 142 and displays images corresponding to the decompressed pixel data using display 144.

In some embodiments, display module 140 is a tightly integrated module. For example, decompression circuitry 142 and display 144 may be located on a single assembly such as a single circuit board or a multi-chip module. Also for example, all of display module 140 may be integrated on a single silicon substrate that is manufactured as a single integrated unit.

Node 135 represents one or more conductors to allow compressed pixel data to be communicated from controller 130 to display module 140. For example, node 135 may be a bus between integrated circuits or modules, and the bus is driven by signal drivers on controller 130 and signals are received by signal receivers in display module 140. Because the pixel data on node 135 is compressed, less power is dissipated by the data transmission to the display than if the pixel data were transmitted without compression.

In some embodiments, controller 130 is included in a system on a chip (SOC) device. For example, a highly integrated SOC device may include all or a portion of processing system 120 and one more controllers, such as a memory controller, an input output (I/O) controller, or controller 130.

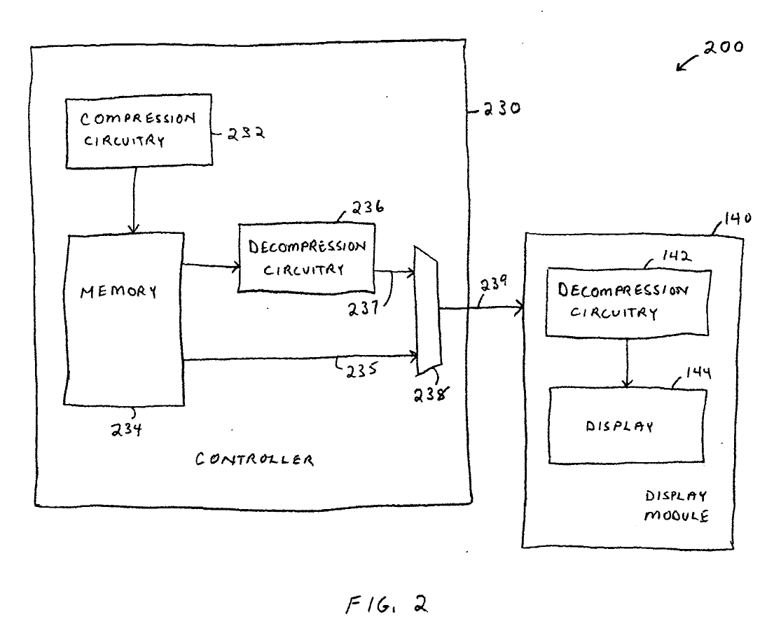

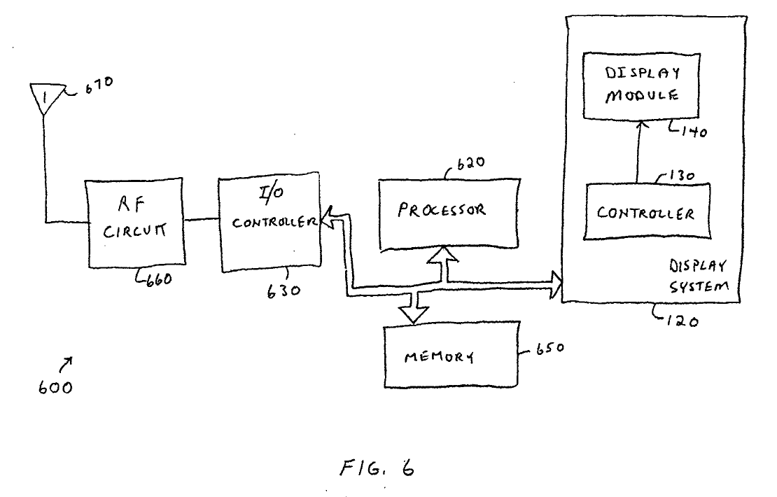

FIG. 2 shows a display system in accordance with various embodiments of the present invention. Display system 200 includes controller 230 and display module 140. Display system 200 and the various display systems shown in later figures, may be included in any electronic system. For example, any of the disclosed display systems my be included in an electronic systems such as electronic system 100 (FIG. 1) or electronic system 600 (FIG. 6).

Controller 230 includes compression circuitry 232, memory 234, decompression circuitry 236, and multiplexer 238. Compression circuitry 232 is capable of compressing pixel data that will eventually be displayed on display 144. Compression circuitry 232 may use any type of compression algorithm without departing from the scope of the present invention.

Memory 234 holds compressed pixel data provided by compression circuitry 232. Decompression circuitry 236 receives compressed pixel data from memory 234 and provides the decompressed pixel data to multiplexer 238. Multiplexer 238 selects between compressed pixel data on node 235 and non-compressed pixel data on node 237 to provide to display module 140. Accordingly, controller 230 may conditionally provide either compressed or non-compressed pixel data to display module 140. When controller 230 provides compressed pixel data to display module 140 on node 239, a power savings may be achieved, in part because signal drivers in controller 230 may dissipate less power when transmitting compressed pixel data.

In some embodiments, controller 230 may be capable of entering a reduced power state. For example, display system 200 may be included in a handheld device that enters a reduced power state, or “sleep” mode, in order to save power. While in a low power state, controller 230 may power down as many functional blocks as possible while still maintaining the ability to provide pixel data to display module 140 and, therefore, provide a static display on display 144. For example, memory 234 and multiplexer 238 may have power applied even when controller 230 is in a low power state to provide compressed pixel data on node 239 to display module 140. In some embodiments, memory 234 stores a single overlay compressed data buffer to reduce the amount of transistors necessary to keep a static image refreshed while in a low power mode.

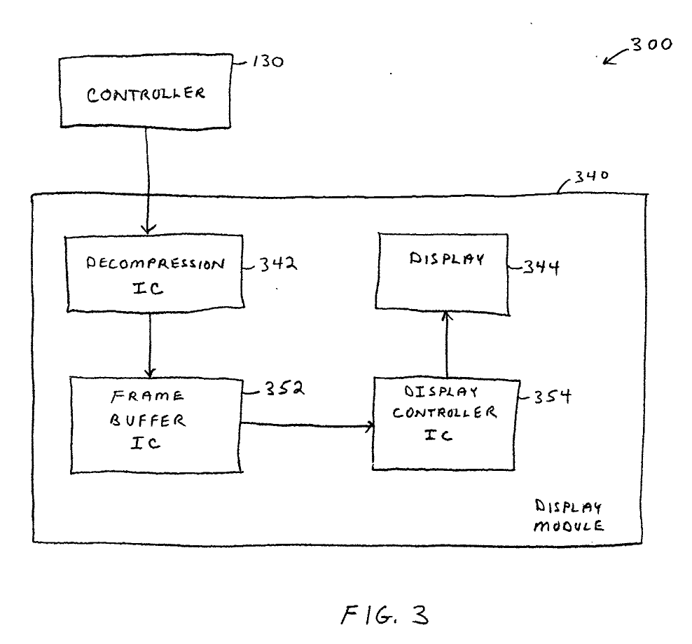

FIG. 3 shows a display system in accordance with various embodiments of the present invention. Display system 300 includes controller 130 and display module 340. Controller 130 is described above with reference to FIG. 1 above, and may include any or all of the functional blocks shown in controller 230 (FIG. 2).

Display module 340 includes decompression integrated circuit (IC) 342, frame buffer IC 352, display controller IC 354, and display 344. In operation, decompression IC 342 receives compressed pixel data from controller 130 and provides decompressed pixel data to frame buffer IC 352. In embodiments represented by FIG. 3, frame buffer IC 352 holds non-compressed pixel data provided by decompression IC 342. Display controller IC 354 receives decompressed pixel data from frame buffer IC 352 and provides it to display 344.

In some embodiments, display module 340 includes a substrate upon which display 344 and the various integrated circuits are placed. For example, display module 340 may be provided as a multi-chip module, and each of the integrated circuits may be bonded directly thereto.

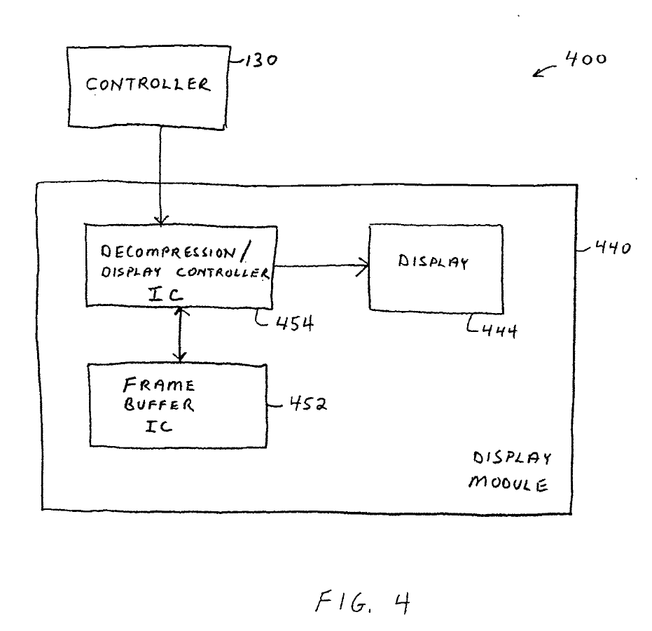

FIG. 4 shows a display system in accordance with various embodiments of the present invention. Display system 400 includes controller 130 and display module 440. Display module 440 includes decompression/display controller IC 454, frame buffer IC 452, and display 444. In embodiments represented by FIG. 4, decompression circuitry and display controller circuitry are integrated together on decompression/display controller IC 454. In operation, decompression/display controller IC 454 receives compressed pixel data from controller 130 and stores decompressed pixel data as necessary in frame buffer IC 452. Further, decompression/display controller 454 receives decompressed pixel data from frame buffer IC 452 as needed to refresh display 444.

In some embodiments, display module 440 includes a substrate upon which display 444 and the various integrated circuits are placed. For example, display module 440 may be provided as a multi-chip module, and each of the integrated circuits may be bonded directly thereto.

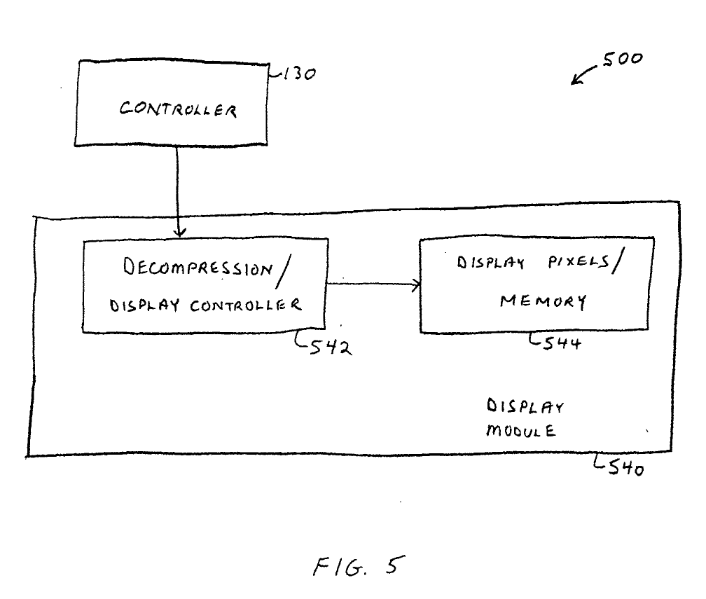

FIG. 5 shows a display system in accordance with various embodiments of the present invention. Display system 500 includes controller 130 and display module 540. Display module 540 includes decompression/display controller 542 and display pixels/memory 544. In embodiments represented by FIG. 5, decompression circuitry and display controller circuitry are integrated together on decompression/display controller 542, and display hardware and memory hardware are integrated together in display pixels/memory 544. In some embodiments, display pixels/memory 544 includes addressable memory for each pixel in the display, and decompression/display controller 542 can write decompressed pixel data to memory at 544 which then refreshes the display at 544.

Display module 540 may have any level of integration. For example, in some embodiments, all of display module 540 is integrated onto a single integrated circuit. In other embodiments, decompression/display controller 542 is on a first integrated circuit, and display pixels/memory 544 is on a second integrated circuit.

FIG. 6 shows a system diagram in accordance with various embodiments of the present invention. FIG. 6 shows system 600 including processor 620, memory 650, input output (I/O) controller 630, radio frequency (RF) circuit 660, antenna 670, and display system 120. Display system 120 includes controller 130 and display module 140. Display system 120 may be any of the display systems described herein, including those shown in FIGS. 2-5. In operation, system 600 sends and receives signals using antenna 670, and these signals are processed by the various elements shown in FIG. 6. Antenna 670 may be a directional antenna or an omni-directional antenna. As used herein, the term omni-directional antenna refers to any antenna having a substantially uniform pattern in at least one plane. For example, in some embodiments, antenna 670 may be an omni-directional antenna such as a dipole antenna, or a quarter wave antenna. Also for example, in some embodiments, antenna 670 may be a directional antenna such as a parabolic dish antenna, a patch antenna, or a Yagi antenna. In some embodiments, antenna 670 may include multiple physical antennas.

Radio frequency circuit 660 communicates with antenna 670 and I/O controller 630. In some embodiments, RF circuit 660 includes a physical interface (PHY) corresponding to a communications protocol. For example, RF circuit 660 may include modulators, demodulators, mixers, frequency synthesizers, low noise amplifiers, power amplifiers, and the like. In some embodiments, RF circuit 660 may include a heterodyne receiver, and in other embodiments, RF circuit 660 may include a direct conversion receiver. In some embodiments, RF circuit 660 may include multiple receivers. For example, in embodiments with multiple antennas 670, each antenna may be coupled to a corresponding receiver. In operation, RF circuit 660 receives communications signals from antenna 670, and provides analog or digital signals to I/O controller 630. Further, I/O controller 630 may provide signals to RF circuit 660, which operates on the signals and then transmits them to antenna 670.

Memory 650 represents an article that includes a machine readable medium. For example, memory 650 represents a random access memory (RAM), dynamic random access memory (DRAM), static random access memory (SRAM), read only memory (ROM), flash memory, or any other type of article that includes a medium readable by processor 620. Memory 650 may store instructions for performing software driven tasks. Memory device 650 may also store data associated with the operation of system 600.

System 600 may include any number of integrated circuits, or “chips,” and may have any level of integration. For example, in some embodiments, processor 620, memory 650, and I/O controller 630 may be separate integrated circuits included in a “chipset.” Further, a chipset may also include controller 130. In some embodiments, the contents of a chipset may be included in a module with a higher level of integration, or may be included on a single integrated circuit. For example, in some embodiments, processor 620, memory 650, I/O controller 630, and controller 130 may be on the same integrated circuit die, or on separate integrated circuit dice packaged together.

Example systems represented by FIG. 6 include cellular phones, personal digital assistants, handheld game devices, or any other suitable system. Many other systems uses for display systems exist. For example, display system 120 may be used in any type of system without an antenna.

Display modules, compression circuits, decompression circuits, display devices, and other embodiments of the present invention can be implemented in many ways. In some embodiments, they are implemented in integrated circuits as part of electronic systems. In some embodiments, design descriptions of the various embodiments of the present invention are included in libraries that enable designers to include them in custom or semi-custom designs. For example, any of the disclosed embodiments can be implemented in a synthesizable hardware design language, such as VHDL or Verilog, and distributed to designers for inclusion in standard cell designs, gate arrays, or the like. Likewise, any embodiment of the present invention can also be represented as a hard macro targeted to a specific manufacturing process. For example, portions of any of the display module embodiments described herein may be represented as polygons assigned to layers of an integrated circuit.

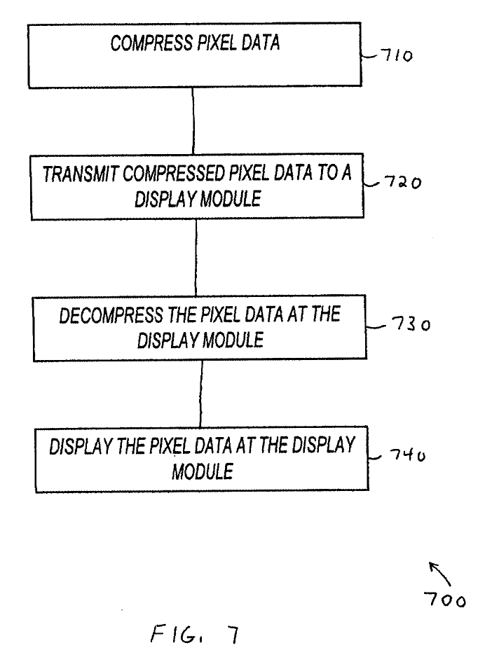

FIG. 7 shows a flowchart in accordance with various embodiments of the present invention. In some embodiments, method 700, or portions thereof, is performed by a display system, embodiments of which are shown in previous figures. In other embodiments, method 700 is performed by an integrated circuit or an electronic system. Method 700 is not limited by the particular type of apparatus performing the method. The various actions in method 700 may be performed in the order presented, or may be performed in a different order. Further, in some embodiments, some actions listed in FIG. 7 are omitted from method 700.

Method 700 is shown beginning with block 710 in which pixel data is compressed. In some embodiments, this corresponds to a controller such as controller 130 (FIGS. 1, 3-6) or controller 230 (FIG. 2) utilizing compression circuitry to compress pixel data prior to transmission to a display module. At 720, compressed pixel data is transmitted to a display module. In some embodiments, this corresponds to transmitting compressed pixel data from a system on a chip (SOC) device to a display module that is separate from the SOC device.

At 730, the pixel data is decompressed at the display module. In some embodiments, this corresponds to a decompression circuit included in any of the display modules shown in the previous figures decompressing the compressed pixel data received from a controller. In some embodiments, the decompressed pixel data, or a portion thereof, is stored in a frame buffer. Further, the frame buffer may be included as memory in a display device such as an LCD with integrated memory. At 740, the display data is displayed at the display module.

In some embodiments, all or a portion of method of 700 may be performed while the device performing it is in a low power mode. For example, a handheld device may be in a low power mode and still perform one or more of the actions in method 700 to reduce power dissipation while maintaining data on a display.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A display module comprising:
a decompression circuit to decompress compressed pixel data received from a source external to the display module; and
a liquid crystal display coupled to the decompression circuit to receive decompressed pixel data.

2. The display module of claim 1 wherein the decompression circuit is included within a first integrated circuit die and the liquid crystal display is included within a second integrated circuit die.

3. The display module of claim 1 wherein the decompression circuit and liquid crystal display are included within one integrated circuit die.

4. The display module of claim 1 further comprising a frame buffer integrated circuit coupled between the decompression circuit and the liquid crystal display.

5. A display system comprising:
a controller capable of sourcing compressed pixel data; and
a display module that includes a decompression circuit to decompress compressed pixel data received from the controller.

6. The display system of claim 5 wherein the controller includes a memory to hold the compressed pixel data.

7. The display system of claim 6 wherein the controller further includes a multiplexer to source either the compressed pixel data or non-compressed pixel data.

8. The display system of claim 7 wherein the controller further includes a decompression circuit coupled between the memory and the multiplexer to conditionally decompress pixel data.

9. The display system of claim 5 wherein the display module includes a liquid crystal display coupled to the decompression circuit.

10. The display system of claim 9 wherein the display module is integrated onto a single silicon substrate.

11. A method comprising:
compressing pixel data;
transmitting compressed pixel data to a display module;
decompressing the pixel data at the display module; and
displaying the pixel data at the display module.

12. The method of claim 11 wherein displaying the pixel data comprises displaying the pixel data on a liquid crystal display.

13. The method of claim 11 wherein compressing pixel data comprises compressing pixel data using a controller separate from the display module.

14. The method of claim 13 wherein transmitting compressed pixel data comprises transmitting compressed pixel data from the controller to the display module.

15. An electronic system comprising:
an antenna;
a radio frequency circuit coupled to the antenna;
a processor coupled to the radio frequency circuit; and
a display system that includes a controller capable of sourcing compressed pixel data, and a display module that includes a decompression circuit to decompress compressed pixel data received from the controller.

16. The electronic system of claim 15 wherein the controller includes a memory to hold the compressed pixel data.

17. The electronic system of claim 16 wherein the controller further includes a multiplexer to source either the compressed pixel data or non-compressed pixel data.

18. The electronic system of claim 17 wherein the controller further includes a decompression circuit coupled between the static memory and the multiplexer to conditionally decompress pixel data.

19. The electronic system of claim 15 wherein the display module includes a liquid crystal display coupled to the decompression circuit.

20. The electronic system of claim 19 wherein the display module is integrated onto a single silicon substrate.
